(19) United States
(12) Patent Application Publication
(10) Pub. No.: US 2006/0237591 A1
(43) Pub. Date: Oct. 26, 2006

(54) OPERATIONAL GROUND SUPPORT SYSTEM HAVING AUTOMATED FUELING

(76) Inventors: William R. McCoskey, Bothell, WA (US); Richard N. Johnson, Anacortes, WA (US)

Correspondence Address: OSTRAGER CHONG FLAHERTY & BROLTMAN, P.C., 250 PARK AVENUE, SUITE 825, NEW YORK, NY, 10177-0899, US

(21) Appl. No.: 11/161,492

(22) Filed: Aug. 5, 2005

Related U.S. Application Data
(63) Continuation-in-part of application No. 10/711,610, filed on Sep. 28, 2004.

(51) Int. Cl. B64D 37/02

(52) U.S. Cl. 244/135 R

(57) ABSTRACT

An aircraft fueling system (890) includes an underground fuel supply (904). A fuel pump (906) is coupled to the underground fuel supply 904 and is used to supply fuel to an aircraft (902). A fuel probe (908) is coupled to the fuel pump (906) and is extendible to an aircraft fueling port (926). A fuel probe connection sensor (938) generates a connection signal. A controller (924) is coupled to the fuel pump (906) and the fuel probe connection sensor (938) and adjusts the supply of the fuel (904) to the aircraft (902) in response to the connection signal.

### RELATED APPLICATION

The present application is a continuation-in-part (CIP) application of U.S. patent application entitled “Operational Ground Support System”, having U.S. Ser. No. 10/711,610, filed Sep. 28, 2004, which is incorporated by reference herein.

### TECHNICAL FIELD

The present invention relates generally to aeronautical vehicle ground support systems. More particularly, the present invention is related to integrated systems and methods of providing ground support services and automated fueling of an aircraft.

### BACKGROUND OF THE INVENTION

It is desirable within the airline industry to provide efficient aircraft servicing and ground mobility. The more an aircraft is in flight the higher the potential profits associated with that aircraft. Ground handling costs are a significant portion of airlines operating expenses. This expense is driven by the amount of labor and mobile ground equipment required to handle and service aircraft at terminal gates. Some of these costs can include indirect health, safety, and insurance costs pertaining to the ground personnel and direct costs associated with employee turnover and training and due to the diversion of personnel from jobs, such as cargo handling and aircraft repair. Costs are also associated with dispatching inefficiencies. In addition, there are procurement and maintenance expenses associated with ground support vehicles and environmental concerns, due to the fuel burn by these vehicles.

Servicing an aircraft includes passenger boarding and de-planning of the aircraft, cargo servicing, galley servicing, and passenger compartment servicing, which includes cabin cleaning. Timing, sequencing, fueling, air supply, potable water supply, waste water drainage, electrical supply, brake cooling, communications links, and the manner in which aircraft services are performed and provided regulate the turnaround time of an aircraft.

Currently, servicing is performed utilizing passenger-bridges and service vehicles for passenger servicing, galley servicing, cabin cleaning, fueling, air supply, electricity supply, waste water disposal, potable water refurbishment, and cargo handling. Typical passenger-bridges are capable of extending, through the use of telescoping sections, to mate with the aircraft. Passengers servicing refers to the enplaning and deplaning over passenger-bridges on a port side of the aircraft. Vehicles for galley servicing, cabin cleaning, fueling, waste water disposal, potable water refurbishment, and electricity supply are provided at points on either side of the aircraft. The passenger servicing task is performed sequentially with the galley and cabin cleaning servicing in order to prevent interference with passengers and servicing crewmembers.

The use of galley servicing, cabin cleaning, fueling, air supply, electric supply, waste water disposal, potable water refurbishment, and cargo handling vehicles can be time consuming due to the steps involved in servicing the aircraft and the aircraft servicing location availability. The servicing vehicles typically need to be loaded at a location that is a considerable distance from and driven over to an airline terminal of interest, mated to the aircraft, and unloaded to service the aircraft. Aircraft servicing location availability is limited, since most vehicle servicing of the aircraft can only be performed from the starboard side of the aircraft to prevent interference with the passenger bridge on the port side of the aircraft. The hydrant fuel, aft cabin cleaning, and aft lavatory service trucks can access the port side. Mating of the servicing vehicles to the aircraft is also undesirable since an aircraft can potentially be damaged.

Current servicing of an aircraft is not efficient and current bridge designs are not physically applicable to newly introduced faster flying aircraft. For example, a sonic cruiser is being studied by The Boeing Company that has a canard wing in an upper forward portion of the aircraft, which interferes with current passenger bridge designs. Also, due to the relationship of aircraft servicing doors and aircraft wings, long turnaround times are required for servicing the sonic cruiser. The longer time spent servicing the aircraft on the ground negates the benefit of the faster flying capability in terms of overall aircraft utilization. System inefficiency of existing infrastructure and current aircraft fleet present restrictions encountered by the Sonic Cruiser.

There are also a considerable amount of costs associated with the fueling of an aircraft. Some of these costs are associated with water treatment costs driven by fuel spills, fuel vapor release, potential damage to an aircraft due to contact with and close proximity of the fuel trucks, and other associated costs.

It is therefore desirable to provide improved aircraft servicing systems and methods with increased fuel servicing efficiency and reduced costs associated therewith.

### SUMMARY OF THE INVENTION

One embodiment of the present invention provides an aircraft fueling system that includes an underground fuel supply. A fuel pump is coupled to the underground fuel supply and is used to supply fuel to an aircraft. A fuel probe is coupled to the fuel pump and is extendible to an aircraft fueling port. A fuel probe connection sensor generates a connection signal. A controller is coupled to the fuel pump and the fuel probe connection sensor and adjusts the supply of the fuel to the aircraft in response to the connection signal.

The embodiments of the present invention provide several advantages. One such advantage is the provision of an integrated aircraft fueling system that combines aircraft fueling with overall ramp operations. The fueling system allows for an aircraft to be fueled and defueled systematically without or with minimal human intervention, as well as without the use of fueling trucks.

Another advantage provided by an embodiment of the present invention is the provision of an integrated aircraft fueling system that allows for the fueling and defueling of an aircraft through fueling connections and probes that are within, stored and extendible from a tarmac. This decreases tarmac congestion, aircraft damage, and allows for various aircraft of different types, styles, and sizes to be fueled and defueled over a particular tarmac area.

Yet another advantage provided by an embodiment of the present invention is the provision of an integrated aircraft fueling system that allows for the externally reading of aircraft fuel capacities, available fueling ports, and current fuel levels. This allows for accurate and efficient fueling and defueling of an aircraft.

The above-stated advantages in addition to other advantages of the present invention allow for efficient fueling of an aircraft, such that precise fueling of an aircraft may be performed between each flight. This minimizes fuel load or weight on an aircraft during each flight, thereby, reducing fuel consumption and costs.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention, reference should now be made to embodiments illustrated in greater detail in the accompanying figures and described below by way of examples of the invention wherein:

FIG. 1 is a top view of an integrated operational ground support system for an aircraft in accordance with an embodiment of the present invention.

FIG. 2A is a top view of an airport illustrating aircraft guidance and mobility including aircraft departure in accordance with an embodiment of the present invention.

FIG. 2B is a top view of an airport illustrating aircraft guidance and mobility including aircraft arrival in accordance with an embodiment of the present invention.

FIG. 3 is a perspective view of an aircraft guidance and mobility system in accordance with an embodiment of the present invention.

FIG. 4 is a side perspective view of the integrated operational ground support system illustrating an aircraft primary service system in accordance with an embodiment of the present invention.

FIG. 5 a perspective view of a tarmac interface service system in accordance with an embodiment of the present invention.

FIG. 6 is a logic flow diagram illustrating a method of servicing an aircraft in accordance with an embodiment of the present invention.

FIG. 7 is a perspective view of a fuel hydrant supply system in accordance with yet another embodiment of the present invention.

FIG. 8 is a perspective view of a machine vision alignment system in accordance with another embodiment of the present invention.

FIG. 9 is a perspective view of a fuel hydrant supply and brake cooling system incorporating a drainage system in accordance with another embodiment of the present invention.

FIG. 10 is a front and block diagrammatic view of an integrated aircraft fueling system in accordance with an embodiment of the present invention;

FIG. 11 is a schematic and block diagrammatic view of a portion of the integrated aircraft fueling system of FIG. 10 in accordance with an embodiment of the present invention.

FIG. 12A is a cross-sectional and block diagrammatic view of an aircraft fueling system incorporating a fueling truck in accordance with an embodiment of the present invention.

FIG. 12B is a front view of a sample fueling truck interface screen in accordance with an embodiment of the present invention.

FIG. 13 is logic flow diagram illustrating a method of fueling an aircraft in accordance with an embodiment of the present invention.

### DETAILED DESCRIPTION

In each of the following Figures, the same reference numerals are used to refer to the same components. While the present invention is described with respect to systems and methods of servicing an aircraft, the present invention may be adapted for various applications and systems including: aeronautical systems, land-based vehicle systems, or other applications or systems known in the art that require servicing of a vehicle.

In the following description, various operating parameters and components are described for one constructed embodiment. These specific parameters and components are included as examples and are not meant to be limiting.

Also, in the following description the terms “service”, “services”, and “servicing” may include and/or refer to any aircraft services, such as passenger ingress/egress services, cargo ingress/egress services, aircraft primary services, aircraft secondary services, galley services, cabin cleaning services, lavatory services, or other services known in the art. Primary services may include fuel, power, water, waste, air conditioning, engine start air, brake cooling, and other primary services. Secondary services may include cabin cleaning services, galley services, trash services, and other secondary services.

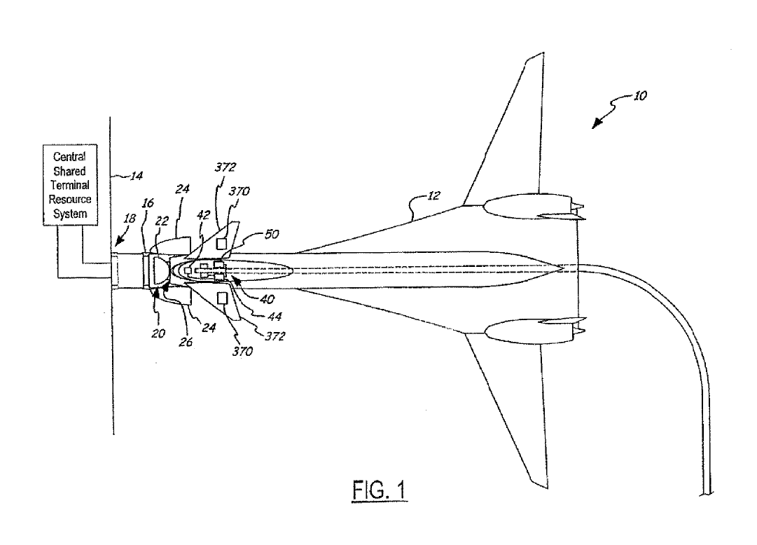

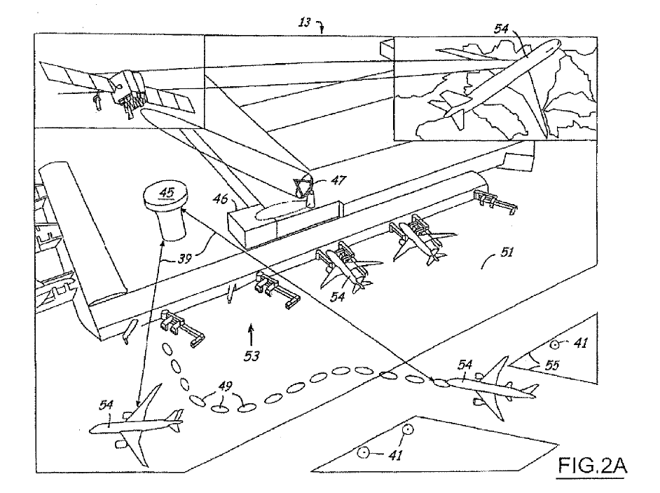

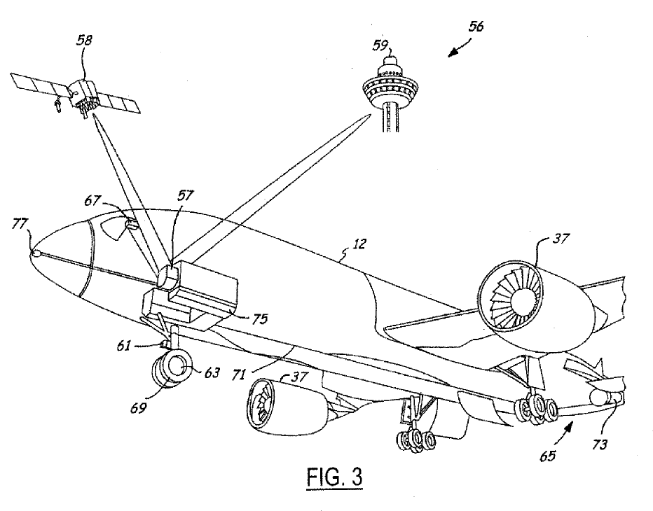

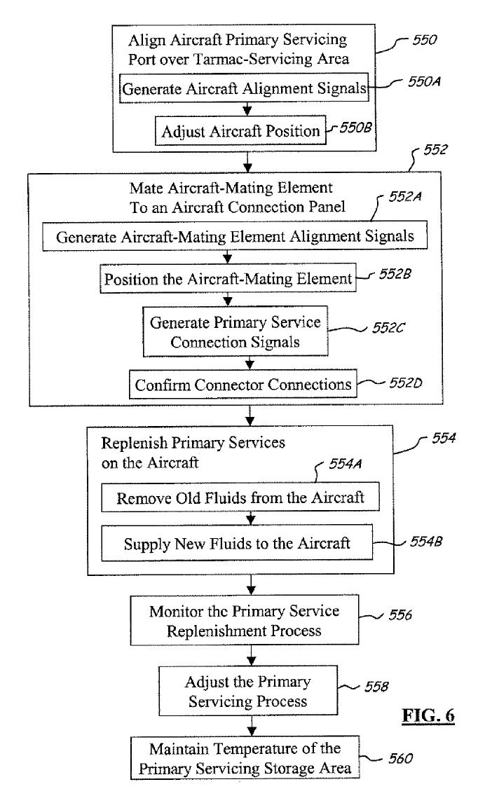

Referring now to FIGS. 1-2B, a top view of an integrated operational ground support system 10 for an aircraft 12 and top views of an airport 13 illustrating aircraft guidance and mobility in accordance with an embodiment of the present invention is shown. Note that the aircraft shown in FIGS. 1-5, as well as in FIGS. 7-12A, are for example purposes only, the present invention may be applied to various other aircraft known in the art. The integrated support system 10 includes the aircraft 12 and an airport interface terminal docking port 14 having a docking coupler or port 16. The aircraft 12 is shown at a particular gate 18 of the interface terminal 14. The aircraft 12 has a nose 20 that opens for the servicing of the aircraft 12 therethrough. The aircraft nose 20 may open in various manners. In the embodiment of FIG. 1, the nose 20 has an upper nose cap 22 and a pair of lower quarter covers 24, sometimes referred to as clamshell doors. The cap 22 and covers 24 are hinged to open in an upward direction and away from a service opening 26. Service opening 26 is one example of a service opening, other examples are provided below with respect to the other embodiments of the present invention. The interface terminal 14 services the aircraft 12 through the service opening 26. The interface terminal 14 provides such servicing through the use of various ground service support sub-systems, which are best seen in FIG. 4. Other sample support sub-systems and integrated operational ground support systems may be incorporated.

The aircraft 12 may include an onboard aircraft terminal mating control system 40 for guidance of the aircraft 12 to and from the terminal 14. The onboard system 40 includes a global positioning system (GPS) or navigation system 42, which is in communication with GPS satellites 43 (only one is shown) and central tower 45 and is used by the controller 44 to guide the aircraft 12 upon landing on the ground to the terminal 14. This guidance may be referred to as vehicle free ramp operations.

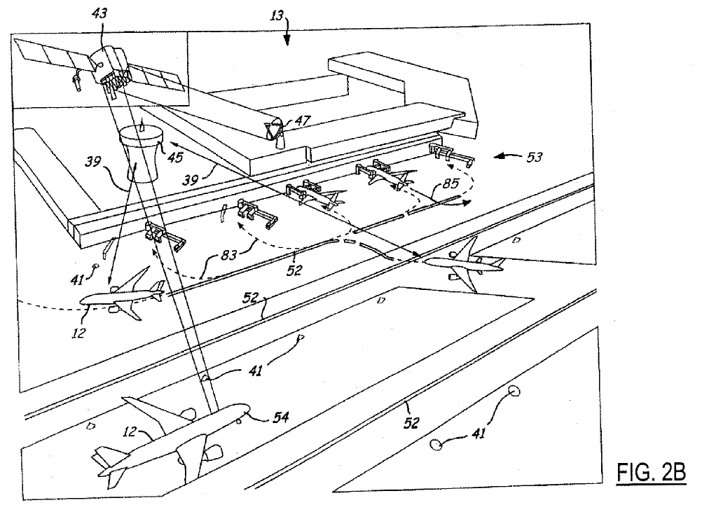

The main controller 18 permits normal ground taxi and gate operations with the main engines 37 of the aircraft 12 in a depowered or OFF state and relies on power from aircraft auxiliary power units to operate electric wheel motors integrated into the nose wheel hubs. Of course, although not shown, wheel motors may be incorporated in landing gear other than in the nose landing gear. Examples of an auxiliary power unit, electric wheel motors, and nose wheel hubs are shown in FIG. 3. Incorporating means to maneuver the aircraft 12 on the ground with only auxiliary power enables the main engines 37 to be OFF. This enables a fully automated gate. This also enables all aircraft ground movements to be under a single remote source control, such as the tower 45.

In another embodiment, the power for the motor wheel may be supplied by any one or several means of ground power supply known within the industry. The ground power distribution and pick up further reduces the noise, air, and water pollution produced at the airports.

The airport infrastructure includes maintenance operations scheduling and support 46 and may be in communication with the aircraft 54 via the tower 45 or the ground antenna 47. Systems, equipment, and personal needed to perform unscheduled service requirements discovered in flight may be ready upon arrival of the aircraft 12 and 54 for such performance.

Guidance signals 39 are transmitted and received between the tower 45 and the aircraft 54 when on the tarmac 51. This assures that adequate ground separation is maintained and discreet source ground movement damage is minimized. The guidance signals are utilized for both arrival and departure as indicated by arrival arrows 83 and backup arrow 85.

The largest percentage of damage to an aircraft occurs while an aircraft is on the ground. The damage may occur when taxiing and colliding with other aircraft or ground equipment, or while parked at a terminal gate by support operations vehicles. The onboard system 40 guides the aircraft 12 by automated means and controls the speed and position of each individual aircraft while in motion. The onboard system 40 is tower controlled via automatic pilot and is employed for ground movement. By having aircraft at a particular airport under controlled motion, ground separation requirements can be reduced. A reduction in ground separation requirements increases airport capacity while reducing the risk of collision with other aircraft and objects.

Once the aircraft 12 is in close proximity with the terminal 14, a precision guidance system 50 is used in replacement of the navigation system 42. The precision guidance system 50 precisely guides the aircraft 12 to the docking port 16 using machine vision controlled pick and place robotics techniques known in the art. A near gate proximity guide-strip or guideline 52 is provided on the tarmac 51, which is used for rapid and precise guidance of the aircraft 12 to the docking port 16. A sample path of an aircraft is designated by the disks 49.

The ground support system 10 utilizes GPS cross runaway and tarmac route control. GPS cross runaway refers to the pavement connection between runways that the aircraft 12 crosses when taxiing to and from a terminal tarmac area 53. Tarmac route control refers to the position control of the aircraft 54 on the tarmac 51, which may include control of the aircraft 12, as well as other aircraft known in the art. Aircraft positions are monitored by the guidance system 50 inclusive of GPS via ground based antenna arrays 41 that may be in or on tarmac guide strips 55. Final precision guidance is performed via machine vision. The ground based antenna arrays 43 may be used to perform triangulation in determining aircraft position. Control of the aircraft 54 may be software customized to individualize airport requirements and configurations. The use of GPS cross runaway and tarmac route control in coordination with the guideline 52 enables rapid ground movement and control and precision gate alignment with minimal system implementation cost. In one embodiment of the present invention the guideline 52 is continuous to maintain control of the aircraft 12.

Once the aircraft 12 is staged to the terminal 14, a system based on machine vision technology orients the docking port 16 in vertical and horizontal directions. After alignment, the docking port 16 is extended and mated with the aircraft 12. Once the aircraft 12 is mated to the docking port 16 the clamshell doors 22 and 24 are opened and the aircraft 12 is serviced through the nose 20.

Referring now also to FIG. 3, a perspective view of an aircraft guidance and mobility system 56 in accordance with an embodiment of the present invention is shown. The guidance and mobility system 56 includes a motor drive speed and steering control panel 57 that is in communication with GPS satellites, such as satellite 58, and a radio control tower 59. The control panel 57 receives position information from the GPS satellites 58 for movement control. The control panel 57 also receives a radio control signal from the tower 59 for speed and route control to and from terminal gates. The guidance and mobility system 56 also includes an electronic and electrical control distribution bay 53, a power steering unit 61, a traction motor 63, and a power delivery system 65. The guidance and mobility system 56 may receive signals from the tower 45 for controlling the taxiing of the aircraft 12 to and from a terminal gate. This eliminates the need for wheel walkers and tail walkers, as commonly used for such taxiing.

The distribution bay 53 provides electronic control of and power to aircraft electronic systems. The control panel 57 may be part of the distribution bay 53 or separate as shown.

The power steering unit 61 is utilized to autonomously steer the aircraft 12 through use of the guidance system 56. The power steering system 61 may be overridden by a pilot of the aircraft 12 via the cockpit override 67 or by airport authority control that is external from the aircraft 12.

The traction motor 63 is a motorized wheel that may be located within the hub of the front wheels 69. The motor 63 may be an alternating current (AC) or direct current (DC) motor. The traction motor 63 is activated by the guidance system 56 to move the aircraft 12. The motor 63 may be used to decrease the traveling or taxiing speed of the aircraft 12 without the use of brakes.

The power delivery system 65 includes a supply line 71 and an auxiliary power unit 73. Power is supplied from the auxiliary power unit 73 to the distribution bay 53 via the supply line 71. The auxiliary power unit 73 may be of various types and styles known in the art.

The guidance system 56 may also include a bank of ultra capacitors 75 to supply load during peak power demands, such as when the aircraft 12 is initially moving from a rest position. This is sometimes referred to as a break away motion start. The guidance system 56 may also include a sensor 77 for close proximity guidance. The sensor 77 is coupled to the control panel 57. The sensor 77 detects objects forward of the aircraft 12, such as a terminal gate, and generates a proximity signal, which may be used by machine vision devices to accurately position the aircraft 12.

The guidance system 56 may support conventionally configured aircraft and use main engines as power mobility, while using the guidance control system 56 to guide movement of the aircraft while on the ground, and within proximity of the airport 13.

Referring now to FIG. 4, a side perspective view is shown of an integrated support system 10′ illustrating the primary service system 300 in accordance with an embodiment of the present invention. The primary service system 300 includes a main control panel station 350 and multiple primary service support sub-systems 351. The main station 350 couples to the aircraft 12 via multiple primary service couplers. The primary service couplers include a first series of couplers 352 and a second series of couplers 354. The first couplers 352 are located on the main station 350. The second couplers 354 are located on the aircraft 12 and mate with the first couplers 352. The primary service sub-systems 351 include a fuel system 360, an electrical power system 362, water systems 364, air systems 366, and a brake cooling system 368, which are controlled via a station controller 370.

Each of the primary sub-systems 351 has an associated conduit 372 that extends from the interface terminal through a service conduit extension 373 to the associated first coupler 352. A large separation distance exists between a fuel hydrant 374 and an electrical coupler 376 to prevent electrical arcing to fuel. Other isolation techniques known in the art may also be utilized to separate the fuel hydrant 374 from the electrical coupler 376. Fuel is delivered by the hydrant 374 rather than by fuel trucks, which minimizes deicing requirements caused by cold soaked fuel and provides a constant and desirable temperature fuel year-round.

The fuel system 360, the water systems 364, the air systems 366, and the brake cooling system 368 have associated pumps 400, specifically a fuel pump 402, a potable water pump 404, a gray water vacuum pump 406, a brown water vacuum evacuation pump 408, an air start pump 410, an air conditioning pump 412, and a brake coolant pump 414. The pumps 400 may be located within the main station 350 or may be located elsewhere in the interface terminal or at some other central location whereby multiple interface terminals may share and have access thereto.

The aircraft 12 is refueled through the high-pressure fuel hydrant 374 that extends to and couples with fueling ports 411 (only one is shown) on each side of the aircraft 12 when dual main stations are utilized. Machine vision ensures that the couplers 354 align in their proper orientation while redundant sensors 420 ensure that fuel and other fluids and electricity does not begin to flow until coupling is complete. The sensors 420 may be in the form of contact limit sensors, which are activated when the clamping mechanism 421 is fully actuated. The sensors 420 may be backed up by continuity sensors, which indicate when the clamping mechanism is in a fully clamped position. Feedback sensors 430 from the aircraft fuel storage system 432 indicate when fueling is complete and the fuel tanks 434 are properly filled. Relief valves and flow back devices 429 may be used to ensure that any system malfunction does not result in spillage. The flow back devices 429 may be located at the level or point of entry into the fuel tanks 434 to prevent fuel from being retained in the lower level plumbing or lines (not shown) between the couplers 354 and the fuel tanks of the aircraft. The lower level lines may then be gas inerted after filling is complete.

The fuel hydrant 374 may be double walled and include an inner tube 433 with an outer jacket 435. Fuel is supplied through the inner tube 433. The outer jacket 435 is used to capture vapor and also serve as a relief flow back system. The feedback sensors 430 are connected to the fueling system 432. The fuel supply architecture of the interface terminal provides for underground fuel storage.

Electrical power and potable water couplers are mated similar to that of the fuel coupler 374. The vacuum couplers connect to the holding tank dump tubes 452. The waste tanks 454 may then be vacuumed empty. The air-conditioning coupler connects to the aircraft air duct system 458. The engine start air coupler connects to the aircraft engine start air lines 462. The brake coolant coupler is connected to the cooling lines 474 of the aircraft braking system 476. When dynamic field brakes are utilized heat dissipation within the braking system 476 may be accommodated through other techniques known in the art rather than through the use of the brake coolant 478. The electrical power coupler, the potable water coupler, the vacuum couplers, the air-conditioning coupler, the engine start air coupler, and the brake coolant coupler are not each numerically designated due to space constraints, but are shown and generally designated and included in the first couplers 352.

The main station 350, via the station controller 370, adjusts the amount of fluids, air, and electrical power supplied to and pumped from the aircraft 12. A control panel operator may monitor the main station 350 and shut down any of the sub-systems 351 that are operating inappropriately or the main controller 370 may in and of itself shut down one or more of the sub-systems 351. Although a single main station is shown for a single side of the aircraft 12, any number of main stations may be utilized.

The main station 350 also includes a static contact neutralizing connection 480 that connects with the aircraft 12 before connection by the other couplers 352 and 354. The neutralizing connection 480 eliminates any static charge that may exist between the aircraft 12 and the interface terminal.

A down-load/up-load interface coupler 484 for system health and maintenance monitoring and control is also provided in the main station 350. The down-load/up-load interface coupler 484 is coupled to and is used for offboard monitoring, checking, and adjusting of aircraft onboard electric systems and controls.

The interface terminal 14 is extendable to the aircraft 12 and as such the service conduit 373 are also extendable. The main station 350 may control extension of the interface terminal. The service conduit extension 373 may be telescoping and be extended to or retracted from the aircraft 12.

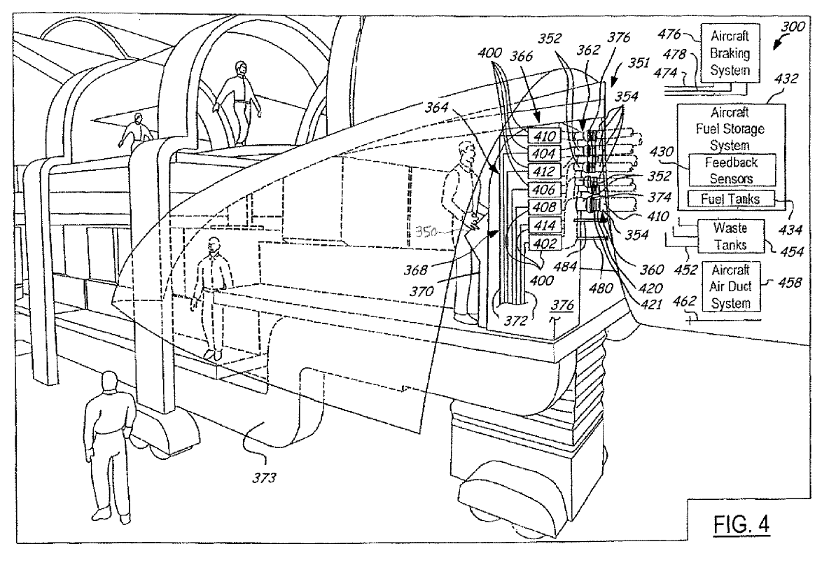

Referring now to FIG. 5, a perspective view of a tarmac interface service system or tarmac-servicing system 500 in accordance with an embodiment of the present invention is shown. The tarmac-servicing system 500 extends out from the tarmac 502 from below ground level and couples to the aircraft 504. The tarmac-servicing system 500 may couple to the aircraft 504 in various locations. The tarmac-servicing system 500 provides primary services to the aircraft 504. Flexible conduit 506 is coupled to the aircraft 504, as shown, and fuel, air, electrical power, water, and coolant may be supplied to the aircraft 504. Fluids, such as potable water system and gray water may be removed from the aircraft 504 or be refurbished. When the tarmac-servicing system 500 is used to supply and remove fuel from the aircraft 504, isolation devices 508 (only one is shown) are used to separate fuel-servicing devices from other primary servicing devices. The isolation devices may be of various types and styles known in the art.

The tarmac-servicing system 500 includes an aircraft-mating plate or element 510 having a first set of connectors, which are coupled to a second set of corresponding connectors on the primary-servicing port or connection panel 512 of the aircraft 504 or the like. Although the first set of connectors and the second set of connectors are not shown in FIG. 5, the connectors may be similar to the couplers 352 and 354 described above and shown in FIG. 4. An adaptor or adaptor kit 514 may be used between the first set of connectors and the second set of connectors. The connection panel 512 may be manufactured to couple directly to the aircraft-mating element 510 or an adaptor kit 514 may be used.

The tarmac-servicing system 500 also includes an alignment system 516. The alignment system 516 includes cameras 518 (only one is shown) and alignment couplers 520 (only one is shown). The alignment system 516 is controlled by vehicle on-board systems to align the cameras 518 with the couplers 520.

Each of the connectors may have an associated sensor, similar to sensors 420 above. A controller, such as the onboard controller 522 or the offboard controller 524, is coupled to the sensors and determines the mating status of the connectors in response to signals received from the sensors. The controller may be any onboard or offboard controller, such as a vehicle onboard servicing controller, a terminal gate controller, or an airport controller.

The tarmac-servicing system 500 is a 5-axis orientation capable system. The tarmac-servicing system 500 includes a base 526 that is positionable in two directions, as shown by the arrows 528. A translational and rotatable table 530 is mounted on top of the base 526. Pivoting arms 532 are mounted on the table 530 and have multiple joints 534 for pivoting and reorienting the aircraft-mating element 510 towards and to mate with the connection panel 512.

The tarmac-servicing system 500 includes one or more alignment and connection devices 536 that are coupled to the controllers 522 and 524, which control the alignment and connection thereof with respect to the connection panel 512. The connection devices 536 and the controllers 522 and 524 may be members of a machine vision alignment system.

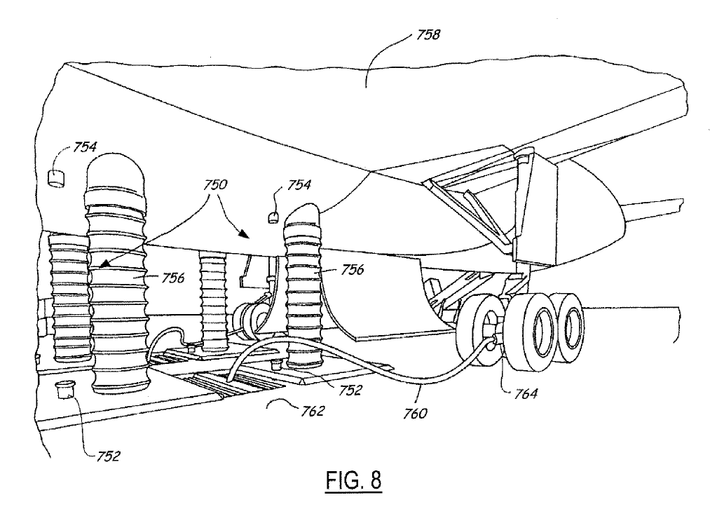

A ramp drainage system 540 is capable of draining various fluids, such as ramp runoff water, deicing fluid, and other ramp fluids. Another sample ramp drainage system is shown in FIG. 9. Fluids may drain through openings 542 in the tarmac 502 where the servicing lines 506 extend therethrough.

The tarmac-servicing system 500 may include a temperature sensor 543 and an air-deicing device 544, which are used to maintain the temperature within a tarmac-servicing system storage area 546 below the tarmac 502. The storage area 546 is maintained above a predetermined temperature. The air-deicing device 544 may include a pressurized air supply device, a terminal air supply device, a fan, a heat exchanger, or other deicing or temperature-maintaining device known in the art.

The tarmac-servicing system 500 is adjustable via one or more motors 550 that are used to extend, orient, and position the aircraft-mating element 510. The tarmac-servicing system 500 is capable of being adapted to various aircraft and adapted to couple to aircraft in various positions through employment of precision location detection devices in conjunction with robotic and adaptable axis movement capability. Samples of these precision devices are provided by the couplers 518 and 520 and the controllers 522 and 524.

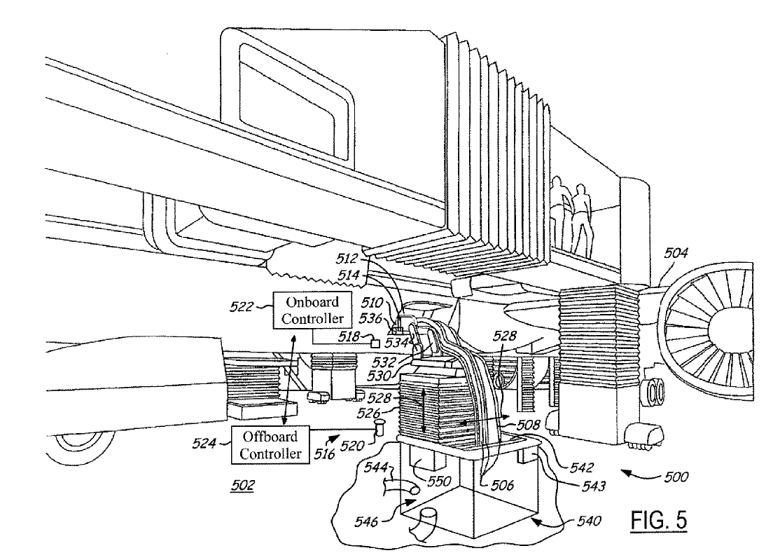

Referring now to FIG. 6, a logic flow diagram illustrating a method of servicing an aircraft 504 in accordance with an embodiment of the present invention is shown. Although steps 550-562 are described primarily with respect to the embodiment of FIG. 5, they may be modified to apply to other embodiments of the present invention.

In step 550, the primary servicing port or connection panel 512 of the aircraft 504 is aligned over the primary servicing area and the tarmac-servicing system 500. This alignment is considered part of the docking process. In step 550A, the cameras 518 generate alignment signals. In step 550B, the controllers 522 and 524 adjust the position of the aircraft 504 in response to the alignment signals.

In step 552, upon alignment of the aircraft 504, the tarmac-servicing element 510 is extended out from said tarmac 502 to mate to the aircraft 504. In step 552A, the alignment devices 536 generate aircraft mating element signals. The alignment devices may include a camera, a machine vision device or system, an infrared sensor, or other alignment sensor known in the art. In step 552B, the controllers 522 and 524 adjust the position of the aircraft-mating element 510 in response to the mating element signals.

In step 554, the aircraft-mating element 510 is connected to the connection panel 512. In step 554A, the connection sensors 536 generate aircraft-mating element alignment signals. In step 554B, the aircraft-mating element 510 is aligned with the connection panel 512 in response to the aircraft-mating element alignment signals. In step 554C, the connection sensors 536 generate primary service connection signals. In step 554D, the controllers 522 and 524 confirm connection of the connectors in response to the connection signals.

In step 556, the primary services are replenished on the aircraft 504 in response to the confirmed tarmac-servicing element connection with the connection panel 512. In step 556A, old primary services or fluids are removed from the aircraft 504, whereupon they may be reprocessed, separated, and reused or utilized in other industries. Waste material from the lavatories and galleys is extracted to a terminal based treatment center to meet local and federal codes. In step 556B, new primary services are supplied to the aircraft 504.

In step 558, the controllers 522 and 524 monitor volumes, flow rates, and pressures of the primary services to and from the aircraft 504 and in response thereto generate replacement status signals. The controllers 522 and 524 may, for example, monitor supply rate, return rate, supply amount, return amount, supply activation, and return activation of said primary services to and from the aircraft 504. The controllers 522 and 524 may determine the volumes, flow rates, and pressures through stored knowledge of the devices within the tarmac-servicing system 500 and within the aircraft 504. The controllers 522 and 524 may also determine the same via operational status information received from various pumps and storage tank sensors (not shown) or other related sensors and indicators known in the art. The controllers 522 and 524 also verify that electric power quality and proper potable water quantities are supplied to the aircraft 504. The electric power quality and proper potable water quantities may also be determined via aircraft onboard sensors (not shown).

In step 560, the controllers 522 and 524 compare the replacement status signals with desired volumes, flow rates, and pressures and in response thereto adjust the supply of primary services to the aircraft 504.

In step 562, the temperature sensor 543 generates a primary servicing area temperature signal. The controllers 522 and 524 maintain the primary servicing storage area 546 at or above a predetermined temperature via the air-deicing device 544 and in response to the temperature signal.

Referring now to FIG. 7, a perspective view of a fuel hydrant supply system 720 in accordance with yet another embodiment of the present invention is shown. The fuel hydrant supply system 720, as shown, is a four-point hydrant system, which includes two pair of hydrants 722 that extend from the tarmac 724 and couple to the aircraft 726. Each of the hydrants 722 may also have an inner supply tube (not shown, but similar to inner tube 233) and an outer jacket 728 for pulling fumes away from the aircraft 726. The hydrants 722 may be coupled on a side of the aircraft 726 inboard of a wing to body joint 730, as shown, or may be couple to other locations on the aircraft 726.

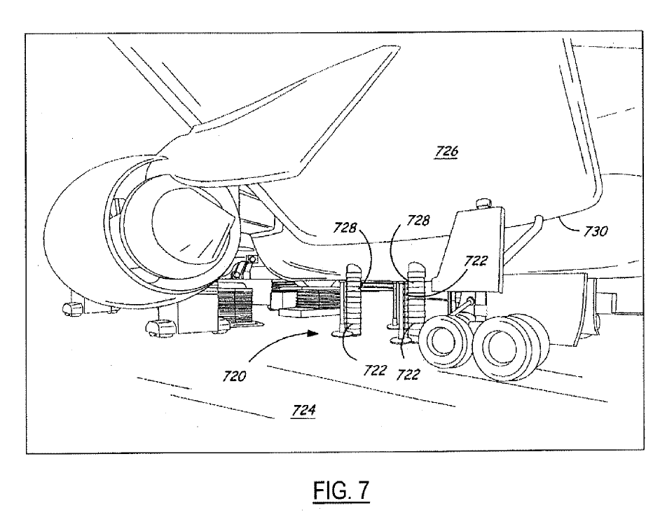

Referring now to FIG. 8, a perspective view of a machine vision alignment system 750 in accordance with another embodiment of the present invention is shown. The alignment system 750 includes cameras 752 and alignment couplers 754. The alignment system 750 is controlled by vehicle on-board systems to align the cameras 752 with the couplers 754. This alignment system 750 aids in aligning the fueling ports of the aircraft 758 with the flow back and vapor collection jackets 756. The sample embodiment of FIG. 20 also illustrates the supply of brake coolant via a coolant line 760 between the tarmac 762 and the brake system 764 of the aircraft 758.

Referring now to FIG. 9, a perspective view of a fuel hydrant supply and brake cooling system 850 incorporating a drainage system 852 in accordance with another embodiment of the present invention is shown. The fuel supply and brake system 850 includes a machine vision alignment system 854 similar to the alignment system 750 with cameras 856 and alignment couplers 858. The fuel supply and brake system 850 also includes fueling ports with flow back and vapor collection jackets 860 and spill traps 862. Any liquid or fuel spillage on the tarmac near the flow back and vapor collection jackets 860 drains through the spill traps 862 underground into an undertarmac level 864 and is isolated from the aircraft 866. A fuel line 868 is coupled to the flow back and vapor collection jackets 860 and to a fuel control valve 870, which is used to adjust the flow of fuel to the aircraft 866. A fluid drain pipe 871 resides in the undertarmac level 864 and allows for drainage of fluids residing therein. The above stated may be referred to as a ramp drainage system.

In addition, tarmac brake coolant vents 872 are provided to allow for cooling air to be emitted from the tarmac 874 and directed at the brakes (not shown) of the aircraft 866. The vents 872 serve as an air vent and as a spill trap. Ambient air may flow through the vents 872. Any fluids leaking from the aircraft 866 near the brakes drains through the vent 872, is collected into a holding reservoir 876, and eventually out a drainage pipe 878. An air supply pipe 880 is coupled to the holding reservoir 876 above a fluid level 882 such that the air does not flow through any fluid contained therein. Air directed at the brakes is represented by arrows 881.

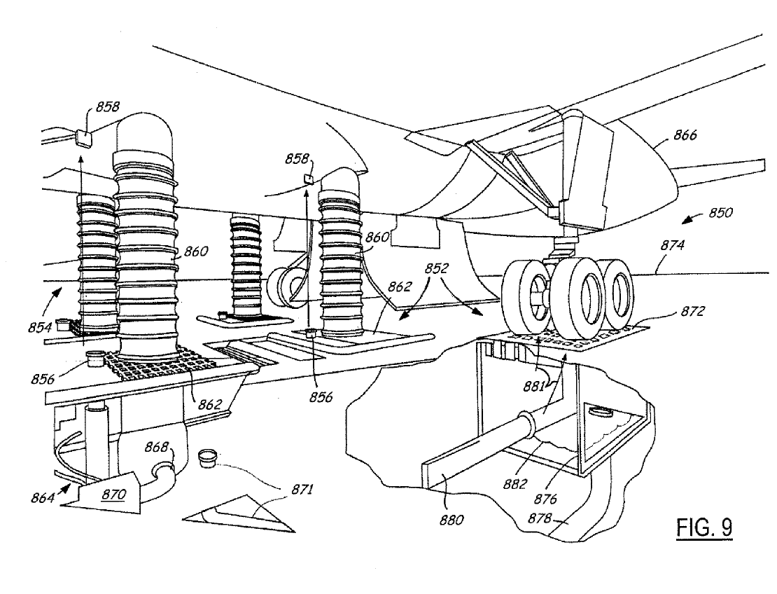

Referring now to FIG. 10, a front and block diagrammatic view of an integrated aircraft fueling system 890 in accordance with an embodiment of the present invention is shown. The aircraft fueling system 890 includes an in-ground fueling station 892 that may be monitored by multiple controllers 894. Any number of controllers may be utilized and they may be located in various locations both onboard and offboard the aircraft 896. In the example embodiment shown, the controllers 894 include an onboard controller 897, a safety or gate controller 898, and an airlines operation controller 899. The controllers 894 allow pilots, ground personnel, and airlines operations to monitor the fueling and de-fueling process. The onboard controller 897 may be part of a fuel quantity indication system and may communicate fuel quantity related information to the offboard controllers 898 and 899. The controllers 894 monitor and assure accurate and appropriate fueling and de-fueling of the aircraft fuel tanks (not shown).

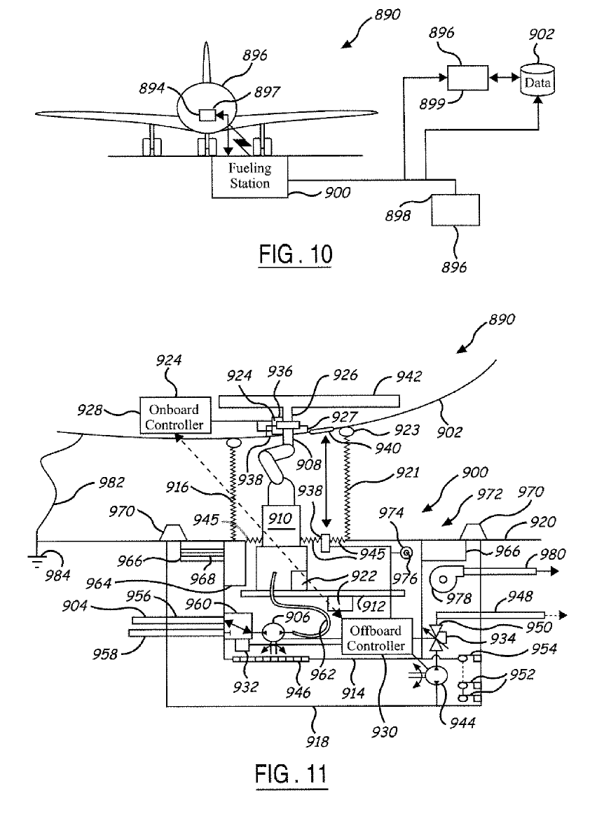

The controllers 894 may be in communication with each other and/or in communication with the in-ground station 900. The in-ground station 900 may communicate with the controllers 894 via multiple sensors, as shown in FIG. 11 or via an in-ground controller, such as the gate controller 898 (not shown). The controllers 894 may communicate with each other via wire or wireless communication. The controllers 894 store and access data from a central offboard data storage unit 902.

The fueling station 900 provides the capability to perform fueling and de-fueling functions for various aircraft models. This includes monitoring quantities of fuel added or drained from each aircraft fuel tank. Direct or indirect interface with the onboard controller 897 is used to verify loading and center of gravity data.

Referring now to FIG. 11, a schematic and block diagrammatic view of a portion of the integrated aircraft fueling system 890 in accordance with an embodiment of the present invention is shown. As stated the fueling system 890 includes the in-ground station 900, which is used to fuel and de-fuel the aircraft 902. The in-ground station 900 includes or has access to an underground fuel supply 904 and one or more pumps 906 that are used to supply new gas and drain or remove old gas and related fluids and contaminants from the aircraft 902. Fuel is supplied and removed from the aircraft 902 via a fuel probe 908 that is mounted on a 5-axis adjustable positioning head 910. The positioning head 910 is located on a positioning bed 912, which is contained within a fuel pit 914. The fuel probe 908 is extended from the fuel pit 914 through a vapor barrier 916 to the aircraft 902. The vapor barrier 916 may be formed of aramid, polyester, nylon, or polytetrafluroethylene, such as Kevlar® or Teflon®, or other suitable materials. The fuel pit 914 is contained and stored within a spill collection reservoir 918. The collection reservoir 918 is disposed below a tarmac level 920 and collects fluid that drains or leaks from any fueling devices within and over the fuel pit 914, as well as from any devices within the vapor barrier 916, and above the tarmac level 920. The vapor barrier having a jacket 921 and an aircraft seal 923.

The positioning head 910 is moved and reoriented via multiple motors, as represented by boxes 922. Controllers 924 are coupled to the motors 922 and extend the fuel probe 908 to the aircraft fueling port 926 through operation thereof. The fueling port 926 is coupled to a fuel panel 927 of the aircraft 902. The fueling probe 908 is coupled to the fueling port 926 via a connector 929.

Operation of the fueling station 900 may be controlled by the onboard controller 928 or via the offboard controller 930. The controllers 924 receive status signals from various sensors, such as fuel valve position sensor 932, a sump valve position sensor 934, one or more connection sensors 936, and alignment and/or identification sensors 938. The connection sensors 936 may be coupled to the aircraft fueling connector/port 926 and/or to the fuel probe 908. The identification sensors 938 may be used to read a recognition code off of an identification plate 940 on the aircraft 902 to determine make, model, and other related information of the aircraft 902. Of course, other related sensors may also be utilized. The fueling port 926 is shown as being at or near the wing root on the body fairing of the aircraft 902 and as being coupled to a crossover manifold 942, which may be coupled to right, left, and center fuel tanks (not shown) of the aircraft 902. The fueling port 926 may be in other locations on the aircraft 902. The controllers 924 when performing the fueling process may determine the available fuel port for performing the stated process.

The controllers 924 also receive status signals from the fuel pump 906 and the sump pump 944. The sump pump 944 is located within the collection reservoir 918 and is used to remove fluids collected therein. Fluids and vapors are drawn from within the vapor barrier 916 into the fuel pit 914 through vents or drains 945. Fluids drain from the fuel pit 914 into the collection reservoir 918 via drains or vents 946. The sump pump 944 is used to pump the fluids out through a fuel sump return line 948 for collection processing. A sump valve 950 is coupled between the sump pump 944 and the sump return line 948. The sump pump 944 and the sump valve 950 may be coupled to sump On/Off limit switches 952 and to emergency limit switches 954 (only one is shown), as desired. The controllers 924 may be coupled to the sump pump 944, the sump valve 950, and the limit switches 952 and 954 for monitoring and control of the fuel station 900 and devices contained therein. The limit switches 952 and 954 may be used in generating a warning alarm to indicate the level of fluid within the collection reservoir 918.

Fuel is supplied to the fuel pump 906 via a supply line 956 and removed from the aircraft 902 via a return line 958 through a fuel pump selection valve 960. The selection valve 960 has three positions: supply/ON, return, and closed/OFF. Between the fuel pump 906 and the positioning head 910 fuel passes through a flexible fuel line 962. The flexible line 962 allows for orienting and positioning of the positioning head 910 on the bed 912.

The fuel system 900 also includes fuel pit cover storage 964 and spill control equipment storage 966. The fuel pit cover storage 964 stores plates or other covers 968 that may be used to cover the fuel pit 914 when not in use. The fuel pit cover storage 964 may also include motors and mechanisms (not shown) to allow for systematic covering and uncovering of the fuel pit 914. The covering and uncovering of the fuel pit 914 may be controlled via the controllers 924. The spill equipment storage 966 is disposed within the collection reservoir 918 and is used to store spill control bumpers 970. Spill control bumpers 970 may be used for safety reasons to retain large spills within a given area or collection zone 972 surrounded by the bumpers 970.

The fuel system 900 also includes a fire detection and suppression system 974. The fire suppression system 974 may include thermal sensors, optical sensors, smoke sensors, or other fire detection sensors, as denoted by box 976, known in the art for activation of fire suppression material. The fire suppression system 974 may also be activated by the controllers 924 or through other known mechanisms and in response to a fuel or flammable fluid leak or spill to prevent enflaming thereof. The fire suppression system 974 may initiate fuel shutoff in the event of a fire.

A vapor evacuator 978 is also located within and may be used to remove vapors from within the collection reservoir 918 and/or the fuel pit 914. The vapor evacuator 978 assures that no fuel vapor accumulates in the fuel pit 914 to create a fire hazard. The vapor evacuator 978 may include sensors (not shown) for activation and deactivation thereof or may be operated by the controllers 924. The vapor evacuator 978 may be in the form of a fan and used to direct the vapors out of the collection reservoir 918 through a vapor vent 980 to an external separator (not shown) where it may then be processed to reclaim condensed vapor.

The fueling station 900 also monitors the in-ground system to insure proper filling pressures and to prevent surge pressures by controlling pump speeds relative to fueling pressures. The fueling station 900 monitors fuel vapor and sump levels to implement emergency fire protection methods and to control spills.

A grounding cable 982 may be coupled between the aircraft 902 and a tarmac ground 984 to prevent spark or electrostatic discharge. The cable 982 is located outside and away from the collection zone 972. The cable 982 may be stored on or off the aircraft 902.

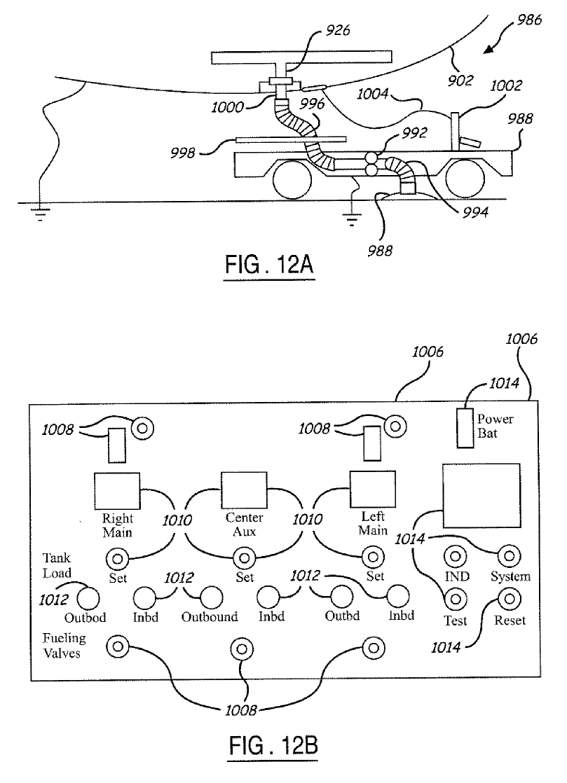

Referring now to FIGS. 12A and 12B, a cross-sectional and block diagrammatic view of an aircraft fueling system 986 incorporating a fueling truck 988 in accordance with an embodiment of the present invention is shown. When an airport is not equipped with an in-ground fueling station, as described above, but has an in-ground fuel supply that may be accessed through the tarmac a fueling truck, such as the fueling truck 988, may be used. The fueling truck 988 is used as a transport medium between the tarmac fuel access site 990 and the aircraft fueling port 926. The fueling truck 988 may include much of the same or similar sensors, pumps, and fire suppression devices described above with respect to the fueling system 900.

The fuel truck 988 includes a fuel pump 992, which is coupled to the fuel access site 988, via a first flex-line 994. A second flex-line 996 is coupled between the fuel pump 992 and a hose lift 998. The second flex-line 996 may extend to the hose lift 998 or may have a fuel probe 1000 and extend through the hose lift 998 to connect to the aircraft fuel port 926. Of course, any number of flex-lines may be used.

The fuel truck 988 also includes a control panel 1002, which may be coupled to the aircraft 902 wirelessly or via an interface cable 1004, as shown. A sample indication interface screen 1006 is shown illustrating the status of various devices on the fuel truck and the status of the aircraft fuel tanks.

The interface screen 1006 includes status indicators of the fueling and de-fueling valves 1008, of the right, center, and left fuel tank levels 1010, the direction of fluid in and out of the fuel tanks 1012, status of a vehicle battery 1014, and other various indicators 1014. In addition to fueling operations, the interface screen 1006 may be used as a link to other ground monitors (not shown).

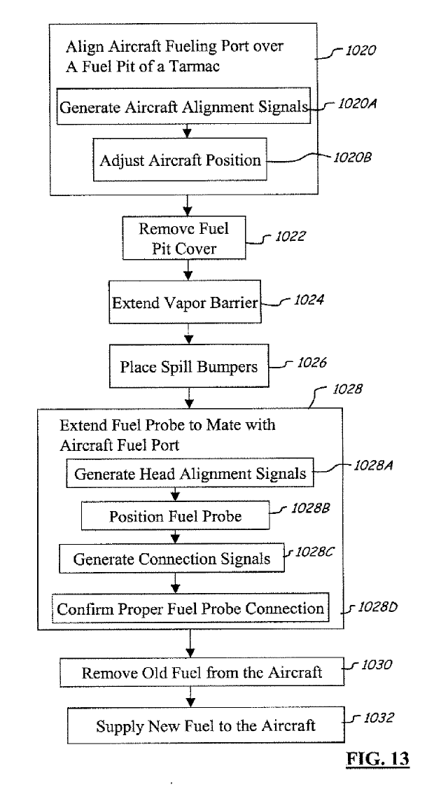

Referring now to FIG. 13, a logic flow diagram illustrating a method of fueling an aircraft 902 in accordance with an embodiment of the present invention is shown. Although steps 1020-1032 are described primarily with respect to the embodiment of FIGS. 8 and 11, they may be modified to apply to other embodiments of the present invention.

In step 1020, the aircraft fuel port 926 is aligned over a fuel station 900 or over a fuel pit 914 of a tarmac within the collection zone 972. This alignment is considered part of the docking process. The alignment system 750 or the sensors 938 may, for example, be used to properly align the aircraft. In step 1020A, the cameras 752 generate vehicle alignment signals. In step 1020B, the controllers 924 may align the cameras 752 with the couplers 754 in response to the vehicle alignment signals.

In step 1022, a fuel pit cover 968 is removed from the fuel pit 914 to expose the positioning head 910. The fuel pit cover 914 may be manually or automatically removed and stored within the cover storage area 966.

In step 1024, the vapor barrier 916 is extended from the tarmac over the fuel pit 914 and is coupled and sealed to the aircraft. The vapor barrier 916 prevents vapors and fluids from escaping during the fueling process. Any vapors and fluids that exist within the vapor barrier 916 are drawn into the fuel pit 914 through the vents or drains 945. The vapor barrier 916 may also be manually or automatically extended.

In step 1026, the spill bumpers 970 are placed around the fuel pit 914 and the vapor barrier 916 as desired to meet state and federal environmental requirements for spill containment.

In step 1028, the fuel probe 908 is extended out from the tarmac to connect with the aircraft. The fuel probe 908 is extended from the fuel pit 914 within and up through the vapor barrier 916 to the aircraft. In step 1028A, the connection sensors 938 generate head alignment signals. In step 1028B, the controllers 924 position the fuel probe 908 in response to the head alignment signals. In step 1028C, the connection sensors 938 generate connection signals. In step 1028D, the controllers 924 confirm proper connection of the fuel probe 908 to the aircraft fuel port 926 in response to the connection signals.

In step 1030, defueling of the aircraft is initiated. The controllers 924 position the fuel valve 960 to the return line 958 and activate the fuel pump 906 to pull old fuel from the aircraft. The old fuel is routed to airport fuel reprocessing centers.

In step 1032, upon removal of the old fuel, the controllers 924 cease defueling and initiate fueling of the aircraft. The controllers 924 position the fuel valve 960 to the supply line 904 and activate the fuel pump 906 to supply fuel to the aircraft. The airlines operation planning staff or one of the offboard controllers may determine appropriate fuel load and communicate such loading to the fuel station 900 for proper loading of fuel onto the aircraft. The fuel load may be based upon aircraft usage, flight information, aircraft related data, or other information known in the art. The fuel load may also be determined based on the aircraft code read during the docking process.

Throughout steps 1020-1032 the controllers 924 are monitoring sump levels and removal thereof. The controllers 924 are also monitoring volumes, flow rates, and pressures of the fuel to and from the aircraft and in response thereto generating at least one fuel replacement status signal. The controllers 924 may determine the volumes, flow rates, and pressures through stored knowledge of the devices within the system and operational status information received from the fuel pump 906 and any fuel tank sensors or via other sensors and indicators known in the art.

The controllers 924 compare the fuel replacement status signals with desired volumes, flow rates, and pressures and in response thereto adjust the fueling process. The controllers 924 in response to the status signals may adjust and/or cease the flow of fluids to and from the aircraft. When a leak has been detected or an excessive amount of fluid has collected in the collection reservoir 918, the controllers 924 may cease supplying or removing of fuel from the aircraft. However, in such a situation the sump pump 944 may remain operational to remove the fluid within the collection reservoir 918.

The present invention provides integrated ground support systems that provide shortened gate turn around times and are convenient and efficient. The architecture of the integrated system provides shortened gate turn around cycles, reduced ground support personnel, reduced ground support equipment, and reduced risk of damage to an aircraft through ground support activities. The automated ground service connections enable ground utilities, air, electricity, potable water, and waste products to be evacuated and replenished systematically with minimal human intervention.

Through use of the present invention, the ground support working environment is significantly improved. Ground support personnel are able to service an aircraft within an enclosed environmentally controlled working environment with minimal fumes. Safety is improved and traditional sources of long-term physical aircraft damage are minimized. The ground support personnel are segregated from tarmac noise and environmental elements.

The present invention also improves airport runway capacity and airport throughput. The present invention also minimizes ground support equipment needed for servicing of an aircraft. The present invention reduces day-to-day stress placed on an aircraft by making gate interfaces consistent and dependable.

The above-described apparatus and method, to one skilled in the art, is capable of being adapted for various applications and systems including: aeronautical systems, land-based vehicle systems, or other applications or systems known in the art that require servicing of a vehicle. The above-described invention can also be varied without deviating from the true scope of the invention.

What is claimed is:

1. An aircraft fueling system comprising:
an underground fuel supply;
at least one fuel pump coupled to said underground fuel supply and used to supply fuel to an aircraft;
a fuel probe coupled to said at least one fuel pump and extendible to an aircraft fueling port;
a fuel probe connection sensor generating a connection signal; and
a first controller coupled to said at least one fuel pump and said fuel probe connection sensor and adjusting supply of said fuel to said aircraft in response to said connection signal.

2. A fueling system as in claim 1 wherein said underground fuel supply is disposed below a tarmac and accessible via a fuel pit.

3. A fueling system as in claim 1 further comprising at least one motor coupled to said fuel probe, said first controller coupled to said at least one motor and extending said fuel probe to said aircraft fueling port.

4. A fueling system as in claim 1 wherein said first controller is mounted on a servicing truck.

5. A fueling system as in claim 1 wherein said fuel pump is mounted on said servicing truck.

6. A fueling system as in claim 1 wherein said first controller is a controller selected from at least one of an aircraft onboard controller, a fuel truck controller, a primary servicing controller, a terminal controller, and an airport controller.

7. A fueling system as in claim 1 further comprising an aircraft onboard controller in communication with said first controller, said first controller mounted offboard said aircraft.

8. A fueling system as in claim 1 further comprising a multi-axis positioning head coupled to said fuel probe.

9. A fueling system as in claim 1 further comprising a vapor barrier coupled to and between a tarmac and said aircraft.

10. A fueling system as in claim 9 wherein said vapor barrier encloses said fuel probe.

11. A fueling system as in claim 1 further comprising:
a spill collection reservoir disposed below a tarmac level and collecting fluid; and
a fuel pit disposed within said spill collection reservoir, said fuel probe stored within said fuel pit.

12. A fueling system as in claim 11 wherein said at least one fuel pump is mounted within said fuel pit.

13. A fueling system as in claim 11 further comprising a vapor evacuation device disposed within said spill collection reservoir and removing vapors therefrom.

14. A fueling system as in claim 11 further comprising a sump pump removing said fluid from said spill collection reservoir.

15. A fueling system as in claim 1 further comprising at least one limit switch, said first controller adjusting supply of said fuel in response to status of said limit switch.

16. A fueling system as in claim 1 further comprising a fire suppression system in operation with said fueling of said aircraft.

17. A fueling system as in claim 16 wherein said fire suppression system is coupled to and operable via said first controller.

18. A fuel system as in claim 16 wherein said at least one fuel pump comprises a defueling pump.

19. An integrated operational ground mobility and support system comprising:
a tarmac fuel servicing system, having at least one fueling probe, extendible from within at least one area of a tarmac to couple with an aircraft;
at least one sensor coupled to said tarmac fuel servicing system and generating at least one servicing system connection status signal;
an aircraft onboard controller; and
an airport controller in communication with said onboard controller, said aircraft onboard controller and said airport controller controlling fueling and defueling of said aircraft in response to said at least one servicing system connection status signal.

20. A support system as in claim 19 wherein said at least one sensor generates a fuel probe head position signal, at least one of said aircraft onboard controller and said airport controller controlling connection of said fuel probe to said aircraft.

21. A support system as in claim 19 further comprising at least one alignment device selected from a camera, a machine vision device, an infrared sensor, and an alignment sensor that generates an alignment signal, at least one of said aircraft onboard controller and said airport controller controlling connection of said fuel probe to said aircraft in response to said alignment signal.

22. A method of fueling an aircraft comprising:
aligning a fuel port of said aircraft over a fuel pit of a tarmac;
extending a fuel probe out from said tarmac to said aircraft;
aligning and connecting said fuel probe to said fuel port; and
fueling and defueling said aircraft in response to said fuel probe connection with said fuel port.

23. A method as in claim 22 further comprising:
monitoring volumes and flow rates of said fuel to and from said aircraft and in response thereto generating at least one fuel replacement status signal; and
comparing said at least one fuel replacement status signal with a desired volume and a desired flow rate and in response thereto adjusting said fueling and defueling.

24. A method as in claim 22 further comprising:
removing a fuel pit cover from a fuel pit; and
extending a vapor barrier from said tarmac to said aircraft;
wherein extending said fuel probe comprises extending said fuel probe from said fuel pit within and up through said vapor barrier to said aircraft.

25. A method as in claim 22 further comprising:
monitoring fueling and defueling pressures; and
adjusting fueling and defueling in response to said pressures.
